(19) United States
(12) Patent Application Publication
(10) Pub. No.: US 2025/0083234 A1
(43) Pub. Date: Mar. 13, 2025

(54) METHOD OF FORMING AN OBJECT BY ADDITIVE MANUFACTURING WITHIN A FURNACE, AND FURNACE FOR ADDITIVE MANUFACTURE OF AN OBJECT

(71) Applicant: PLASTIPRINT 3D LTD., Mintlaw, Aberdeenshire (GB)

(72) Inventors: Gary CAIRNS, Mintlaw, Aberdeenshire (GB); Argo HOBENAEL, Mintlaw, Aberdeenshire (GB); Andrew LAMBIE, Mintlaw, Aberdeenshire (GB)

(21) Appl. No.: 18/292,446

(22) PCT Filed: Jul. 26, 2022
(86) PCT No.: PCT/EP2022/070930

§ 371 Date: Jan. 26, 2024

(30) Foreign Application Priority Data
Jul. 28, 2021 (GB) 2110857.6

(51) Int. Cl. B22F 10/64; B22F 3/00; B22F 10/85; B22F 12/17; B22F 12/30; B33Y 10/00; B33Y 30/00; B33Y 40/20; B33Y 50/02

(52) U.S. Cl. CPC B22F 10/64; B22F 3/003; B22F 10/85; B22F 12/17; B22F 12/30; B33Y 10/00; B33Y 30/00; B33Y 40/20; B33Y 50/02

(57) ABSTRACT

A method of forming an object by additive manufacturing within a furnace defining a cavity is provided. The method comprises: moving a build plate from a raised position to a lowered position within a cavity, the build plate for receiving build material to form an object thereon while moving from the raised position to the lowered position; and sintering the object within the furnace. The sintering comprises releasing heat from the cavity in the furnace by opening the upper lid. A furnace for additive manufacture of an object is further provided.

### FIELD

The subject disclosure relates generally to additive manufacturing, and in particular to methods of forming an object by additive manufacturing within a furnace, and furnaces for additive manufacture of an object.

### BACKGROUND

Additive manufacturing or three-dimensional (3D) printing is the construction of a 3D object from a computer aided design (CAD) model. The CAD model is used to control hardware to manufacture the object. Additionally 3D object scanners are available to scan objects to create CAD model for additive manufacturing. Rapid prototyping or rapid manufacturing are also terms which may be used to describe additive manufacturing processes.

As used herein, “additive manufacturing” refers generally to manufacturing processes wherein successive layers of material(s) are provided on each other to “build-up” layer-by-layer or “additively fabricate”, a three-dimensional component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an object to be integrally formed and include a variety of features not possible when using prior manufacturing methods.

Additive manufacturing can create complex geometries without the use of any sort of tools, molds or fixtures, and with little or no waste material. Instead of machining components from solid billets of plastic or metal, much of which is cut away and discarded, the only material used in additive manufacturing is what is required to shape the part.

Exemplary additive manufacturing techniques include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNSM), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ), Drop On Demand (DOD), Binder Jetting (BJ), Multi Jet Fusion (MJF), Laminated Object Manufacturing (LOM) and other known processes.

Additive manufacturing may form objects from a variety of materials. For example, the material may be plastic, metal, composite, concrete, ceramic, polymer, epoxy, photopolymer resin, or any other suitable material that may be in solid, liquid, powder, sheet material, wire, or any other suitable form or combinations thereof. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation).

While a variety of additive manufacturing techniques are known, improvements and/or alternatives are desired.

This background serves only to set a scene to allow a person skilled in the art to better appreciate the following description. Therefore, none of the above discussion should necessarily be taken as an acknowledgement that that discussion is part of the state of the art or is common general knowledge. One or more aspects/embodiments of the disclosure may or may not address one or more of the background issues.

### SUMMARY

An aspect of the present disclosure relates to a method of forming an object by additive manufacturing within a furnace.

A variety of additive manufacturing processes may include heat treating, e.g. SLM, once the object has been printed. Heat treating may beneficially release internal tensions accumulated in the object, or optimise properties of the object. In an exemplary process an object is printed by one device at one location, then moved to another location, e.g. a furnace, for heat treating. In this context printing may include dispensing print material such that it is selectively bonded to form a particular desired shape.

The disclosure provides a method and furnace which enables an object to be printed in a furnace, and then heat treated in the same furnace. Printing may refer to dispensing print material such that the material selectively bonds to form a desired shape of the object. In this manner printed objects must not be moved between apparatus/devices thereby reducing the likelihood of damage to the object during movement. Furthermore, the object may have improved physical properties or characteristics, e.g. tensile strength, compressive strength, shear strength, as a result of being heat treated immediately after printing (and selective bonding) and without any movement required.

The furnace may define a cavity. A build plate may be moveable from a raised position to a lowered position within the cavity. The build plate is for receiving build material which is dispensed and selectively bonds (to itself) to form an object on the built plate while the build plate is moving from the raised to lowered position. The build plate may be powder dispensed from a dispenser which selectively bonds to form the object. The raised position may adjacent an opening of the cavity. The raised position may be within the cavity. In this manner an object may be formed on the build plate and then heat treated on the same build plate such that the object need not be moved between forming and heat treatment. This may improve object properties, reduce the likelihood of damage during movement, and reduce costs and time to manufacture the object.

The furnace may comprise side walls enclosing the build plate, and an open end opposite the build plate. The side walls and the build may define cavity. The open end may provide access to the cavity. The build plate may be contained within the cavity by the side walls of the furnace. The build plate may abut the side walls of the furnace. The build plate may be generally planar. The build plate may be generally parallel to the open end of the furnace. The side walls may be perpendicular to the build plate.

Alternatively the side walls may define particular angles with the build plate such that the build plate has a greater or less surface area than the open end of the cavity.

The cavity may define a generally cuboid. The cavity may define other shapes such as cylinder, or a polyhedron, e.g. hexahedron.

The furnace may comprise four (4) side walls. In other configurations more or less sidewalls may be present. For example, the furnace may comprise a single side wall defining a cylindrical cavity with the build plate defining a base of a cylinder shape.

Objects may be printed into the cavity through the open end of the furnace. Objects may be printed onto the build plate of the furnace through the open end of the furnace.

The furnace may comprise a lid affixed to a body of the furnace. The lid may comprise a lower lid and an upper lid affixed to the lower lid. The cavity may be defined within the body of the furnace.

The method may comprise:
moving a build plate from a raised position to a lowered position within a cavity, the build plate for receiving build material to form an object thereon while moving from the raised position to the lowered position; and
heat treating, e.g., sintering, the object within the furnace.

Accordingly, in another aspect there is provided a method of forming an object by additive manufacturing within a furnace comprising a body defining the cavity, and a lid affixed to the body, the lid comprising a lower lid and an upper lid affixed to the lower lid, the method comprising:
moving a build plate from a raised position to a lowered position within a cavity, the build plate for receiving build material to form an object thereon while moving from the raised position to the lowered position; and
sintering the object within the furnace, sintering comprising releasing heat from the cavity in the furnace by opening the upper lid.

Releasing heat from the cavity may comprise opening the upper lid while maintaining the lower lid in a closed position. The closed position of the lower lid may prevent fluid ingress into the cavity while allowing heat release from the cavity.

Releasing heat from the cavity may expose the cavity to the external environment thereby releasing heat from the cavity through the lower lid. The lower lid may comprise insulation and/or refractory material to allow for controlled heat release from the cavity. The upper lid may comprise insulation and/or refractory material having a lower rate of heat transfer than the lower lid.

The method may additionally comprise:
forming an object on the build plate during moving the build plate from the raised position to the lowered position.

As the build plate moves from a raised position to a lowered position within the cavity, the build plate may receive build material which selectively bonds (to itself) to form an object on the built plate, and the object formed by the build material may be heat treated directly at the furnace. Thus the formed object does not need to be moved to another location to undergo heat treatment. This avoids the risk of damage to the object during movement. Further physical properties or characteristics of the object may be improved in comparison to methods which require movement of the object. Additionally forming the object and heat treating the object may be completed more quickly. Thus time and costs may be reduced.

Heat treating is performed subsequent to the moving step. In other words, the method may comprise moving the build plate, and then, subsequent to the moving, heat treating the object within the furnace.

Heat treating may comprise sintering the object within the furnace. Sintering may include heating and cooling the object in an alternating manner. A heat source of the furnace may be used to heat treat the object. The heat source may comprise one or more thermal elements. One or more thermal elements of the furnace may be used to heat and/or cool the object. Thermal elements may include resistive elements, thermistors, heating elements, heating cartridges, and heating pads. Thermal elements may be manufactured from a variety of materials including nickel, chromium, iron, copper, silicon, carbide, nitride, and combinations thereof.

The build plate may be movable in the z axis. Movement of the build plate in z axis may allow for dispensing of build material, e.g. powder to form layers of the object. Powder may be dispensed through the open end of the furnace while the build plate moves in the z axis such that powder forms layers of the object in the z axis. The layers may be generally vertical layers of the object.

The method may further comprise forming an object on the build plate during moving the build plate from the raised position to the lowered position.

Forming the object may comprise selectively bonding the build material on the build plate to form the object.

Forming the object may comprise dispensing build material from a dispenser into the cavity. The build material may comprise powder. The dispenser may comprise a powder dispensing mechanism.

The powder may be dispensed through the open end of the furnace onto the build plate of the furnace to form the base layer. The powder may be dispensed through the open end of the furnace onto the base layer on the build plate to form the one or more layers. Additional powder may be dispensed on or in between the one or more layers to form additional layers.

Dispensing powder to form the object may comprise:
dispensing powder from a support powder dispenser to form a base layer on the build plate of a furnace;
dispensing powder from a build powder dispenser to form one or more layers on the base layer on the build plate of the furnace, the base layer and one or more layers forming the object.

Dispensing powder may further comprise:
dispensing powder from a extruder hopper, and optionally:
refilling the extruder hopper from a main hopper storing powder.

The method may further comprise dispensing build material, e.g., powder, from a dispenser into a cavity. The dispenser may comprise an extruder hopper for storing build material to be dispensed.

The method may further comprise refilling the extruder hopper from a main hopper storing build material. The method may further comprise refilling the extruder hopper from the main hopper upon detecting insufficient build material in the extruder hopper. Build material be detected based on a weight of the extruder hopper.

The method may further comprise dispensing build material, e.g., powder from one of a plurality of dispensers into a cavity. Each dispenser of the plurality of dispensers may store different or the same build materials, e.g., powders with different material properties. The method may further comprise selecting a particular dispenser prior to dispensing build material stored in an extruder hopper associated with the particular dispenser. Selecting the particular hopper may include rotating a mechanism on which the plurality of dispensers are mounted to select the particular dispenser.

During movement of the build plate the side walls may abut the build plate continuously, or at only certain points. Raising or lowering the build plate may increase or decrease the volume of the cavity of the furnace. This may allow for larger or smaller objects to be formed in the furnace.

Heat treating or sintering the object may comprise activating one or more of thermal elements positioned within a lid of the furnace. Thermal elements may include resistive elements, thermistors, heating elements, heating cartridges, and heating pads. Thermal elements may be manufactured from a variety of materials including nickel, chromium, iron, copper, silicon, carbide, nitride, and combinations thereof.

The lid may move between a closed position preventing access to the cavity and the build plate, and an open position allowing for access to the cavity and the build plate. The lid may be affixed to the furnace. The lid may affixed to a side wall of the furnace.

The thermal elements may be surrounded by insulation within the lid in order contain heat within the cavity of the furnace.

The lid may comprise a lower lid and an upper lid affixed to the lower lid. The upper lid may be rotatably connected to the lower lid. The lower lid may rotatably connected to one of the sidewalls of the furnace. The upper lid may be hingedably connected to the lower lid, and the lower lid may be hingedably connected to one of the side walls of the furnace. The upper lid may open in a first direction, and the lower lid may open in a second direction. The first direction may be opposite to the second direction such that the lower lid rotates in the second direction, and the upper lid rotates in the first direction. The lower lid may be connected at a first end of the lower lid to one of the sidewalls. The upper lid may be connected at a second end of the lower lid. The second end may be opposite the first end.

In another configuration the upper and lower lid are retractable to open, and provide access to the cavity. The upper lid may be retractable or slideable in a first direction such that heat released from the cavity is directed away from heat sensitive components of the furnace, such as powder dispensers. The lower lid may be retractable or slideable in a different second direction. Retracting or sliding the lower lid may provide access to the cavity and to an object formed within the cavity.

The lower and/or upper lids may comprise insulation and/or refractory material. The lower lid may comprise insulation and/or refractory material which has a higher rate of heat transfer than the insulation and/or refractory material of the upper lid.

Opening the upper lid, while keeping the lower lid closed, may allow a formed item to cool while protecting elements such as the dispensers or powder dispensing mechanism. In particular, the higher rate of heat transfer of the lower lid may allow for controlled cooling of elements of the furnace.

The higher rate of heat transfer of the lower lid may allow for the object formed and sintered within the furnace, e.g., cavity of the furnace, to be cooled in a controlled manner without exposing the object to atmosphere which may damage the sintered object. An object sintered in the furnace may still be at very high temperatures and exposing them to atmospheric conditions may damage the object. Opening only the upper lid which has a lower rate of heat transfer than the lower lid prevents exposure to atmospheric conditions while also allowing for controlled cooling of the object via the higher heat transfer through the lower lid.

When closed the lower lid may prevent access to the cavity via the open end. When open the lower lid may allow access to the cavity via the open end. When closed the upper lid may overlay the lower lid. When closed the upper and lower lids may define planes which are generally parallel.

Heat treating or sintering the object may comprise opening the upper lid to release heat from the cavity. The lower lid may be opened subsequent to opening the upper lid. The lower lid may be opened to extract the object from the cavity.

Heat treating or sintering may comprise opening the upper lid while keeping the lower lid closed. Opening the upper lid allows the formed item cool while keeping the lower lid closed ensures the formed item is not exposed to oxygen which may cause the formation of detrimental oxides in the item. Opening the upper lid and keeping the lower lid closed may therefore provide a higher quality item in that oxides are not present in the item, or the presence of oxides in the item are reduced.

The thermal elements may located or positioned in the lower lid. Insulation may be located or positioned in one or more of the upper and lower lids.

Heat treating or sintering may comprise releasing heat from the cavity in the furnace by opening the upper lid. Heat treating or sintering may comprise opening the upper lid, but not the lower lid. The upper lid may comprise insulation, and the lower lid may comprise one or more thermal elements. Opening the upper lid may allow for the release of heat from the cavity to cool the cavity in a controlled manner in contrast with opening the upper and lower lids and allowing a complete release of heat from the cavity. Controlled release of heat from the cavity may prevent heat damage to the components of the furnace.

Further the connection between the lower and upper lids may ensure heat is released away from heat sensitive components of the furnace, such as the dispensers.

The upper lid may be rotatably connected to the lower lid such that heat is released from the cavity away from one or more of the support powder dispenser and the build powder dispenser upon opening the upper lid.

One or more of dispensing powder from the support powder dispenser, and dispensing powder from the build powder dispenser comprises dispensing powder through the open end of the furnace.

Dispensing powder from the support powder dispenser may comprise dispensing powder from a broad nozzle.

Dispensing powder from the build powder dispenser may comprise dispensing a metal powder. Metal powder may include stainless steel, tool steel, Inconel™, nickel alloys, titanium, copper, brass, gold, silver, platinum, and combinations thereof.

Dispensing powder from the build powder dispenser may comprise dispensing powder from a fine nozzle.

A fine or detail nozzle may be under 2 mm in diameter. A broad nozzle may be above 2 mm in diameter.

The powder dispensing mechanism may be configured such that powder is dispensed through the open end of the furnace and into the cavity.

Dispensing the base layer and dispensing the one or more layers may comprise positioning the support or build powder dispensers in the x and y axes. Dispensing the base layer and dispensing the one or more layers may comprise positioning the powder dispensing mechanism in the x and y axes. In the manner the dispensing mechanism and/or dispensers may positioned at any x and y point in the open end of the furnace in order to dispenser powder at any point on the build plate or already formed layers, e.g. the base layer.

Positioning the powder dispensing mechanism or dispensers may comprise moving the mechanism or dispensers along one or more of: an x axis linear mechanism and a y axis linear mechanism. The x and y axis linear mechanisms may comprise one or more rails spanning side walls of the furnace. The rails may be located at a periphery of the side walls so as to not interfere with access to the open end and cavity of the furnace.

The method may further comprise remotely controlling one or more of: dispensing powder, moving the build plate, and heat treating or sintering the object. Remotely controlling may comprise controlling via a remotely accessible interface. The interface may be accessible via the Internet via local wired or wireless networks. Remotely controlling may include monitoring temperatures at the furnace via one or more sensors at the furnace. A sensor may be positioned within the cavity and/or at the lid to monitor temperatures.

The method may further comprise dispensing a first material from a first dispenser of the furnace onto the build material, and dispensing a second material from a second dispenser of the furnace onto the build material. The dispensing mechanism may comprise the first and second dispensers.

The method may further comprises vacuum sealing the cavity of the furnace. The method may further comprise pumping a gas into the cavity. The gas may comprise an inert gas. The vacuum sealing and/or pumping may be performed after powder is dispensed, but before heating treating/sintering. Sintering the object in a vacuum or within an inert gas may improve the quality of the sintering thereby improving physical properties of the object such as rigidity.

According to another aspect there is provided a computer readable medium having computer program code stored thereon, the code, when executed by a processor, performing any of the described methods.

According to another aspect there is provided a computer readable medium having computer program code stored thereon, the code, when executed by a processor, controlling an apparatus, e.g., a furnace such as the described furnace to perform any of the described methods.

Any of the described computer-readable mediums may be non-transitory. The computer-readable medium may comprise storage media excluding propagating signals. The computer-readable medium may comprise any suitable memory or storage device such as random-access memory (RAM), static RAM (SRAM), dynamic RAM (DRAM), non-volatile RAM (NVRAM), read-only memory (ROM), or Flash memory.

The processor may have a single-core processor or multiple core processors.

According to another aspect there is provided a computer program product having computer program code stored thereon, the code, when executed by a processor, performing any of the described methods.

According to another aspect there is provided a furnace for additive manufacture of an object. The furnace may allow for printing an object at the furnace and heat treating or sintering the object at the same furnace. Accordingly, the object need not be moved between printing and heat treatment. This may improve the object physical properties, reduce time and costs associated with forming the object, and/or reduce the risk of damage to the object during movement.

The furnace may define a cavity. The furnace may comprise:
a build plate movable from a raised position to a lowered position within the cavity, the build plate for receiving build material to form an object thereon while moving from the raised position to the lowered position;
a heat source for heat treating or sintering the object on the build plate within the furnace; and
a lid comprising an upper lid and a lower lid.

The raised position may be adjacent the cavity. The raised position may be adjacent an open end of the cavity.

The furnace may comprise:
side walls enclosing a build plate, and an open end opposite the build plate, the build plate and side walls defining the cavity.

The furnace may further comprise a fan mounted in a side wall of the furnace. The fan may be positioned within the cavity. The fan may be adapted to remove heat from the cavity.

The build plate may be moveable in the z axis. Movement in the z axis may allow for the volume of the cavity to be increased or decreased to allow for a larger or smaller object to be formed.

The furnace may further comprise a movement mechanism for lowering or raising the build plate in the z axis. The movement mechanism may comprise a threaded rod arranged through the build plate. The rod may be arranged to be rotated via a pulley system connected to a motor. Actuation of the motor may cause rotation raised or lowering of the build plate via the pulley system connected to the threaded rod. While a particular movement mechanism is described various other mechanisms are possible. For example, the movement mechanism may comprise pneumatic or electrical arms.

The lid may be for preventing access to the cavity, or allowing access to the cavity. The lid may be affixed to the furnace. The lid may be affixed to a side wall of the furnace. The lid may be rotatable relative to the side wall. Movement of the lid may allow for access to the cavity within the furnace. The lid may be closed to contain heat within the cavity. Opening the lid may allow for removal of the formed object.

The heat source may be positioned within the lid.

The heat source may comprise one or more thermal elements. The thermal elements may be positioned within the lid. The thermal elements may include resistive elements, thermistors, heating elements, heating cartridges, and heating pads. Thermal elements may be manufactured from a variety of materials including nickel, chromium, iron, copper, silicon, carbide, nitride, and combinations thereof.

The upper lid may be hingeably connected to the lower lid to open in an opposite direction thereto. The lower lid may be connected at a first end to a side wall of the furnace, and the upper lid may be connected at a second end of the lower lid. The first and second ends may be opposite to one another. The ends may be at the periphery of the lower lid.

The heat source may be positioned within the lower lid. The thermal element may be positioned, at least partially, within the lower lid. The lower lid may include a casing for covering a portion of the thermal elements external to the lower lid.

The thermal elements may be positioned within the lower lid. The thermal elements may be positioned such that closing the lower lid allows for the elements to heat treat an object formed within the cavity.

The upper lid may comprise insulation. The insulation may contain heat within the cavity when the lids are closed. Opening the upper lid may allow for controlled release of heat from the cavity. Such controlled release may ensure heat sensitive components, such as the dispensers, are not damaged by heat released from the cavity.

The upper lid may be connected to the lower lid such that the upper lid is adapted to open away from the dispensers. In other words once the upper lid is open heat released from the cavity is more likely to be released away from the dispensers. This may prevent heat damage to the dispensers upon opening the lid. The upper lid may be open prior to the lower lid being opened.

The furnace may further comprise an apparatus for dispensing build material through the cavity. The apparatus may be for dispensing build material to form an object on the build plate. The apparatus may dispense build material through the cavity onto the build plate. The build material may comprise powder.

The furnace may further comprise a powder dispensing mechanism. The powder dispensing mechanism may comprise:
a support powder dispenser for dispensing powder to form a base layer on the build plate; and/or
a build powder dispenser for dispensing one or more layers on the base layer, the base layer and one or more layers forming an object within the furnace.

The powder dispensing mechanisms may comprise:
a plurality of powder dispensers, each powder dispenser for dispensing a different powder. The powder may be dispensed onto the build plate.

The powder dispensing mechanisms may comprise:
a plurality of powder dispensers for dispensing powder on the build plate.

The plurality of powder dispensers may comprise a first powder dispenser for dispensing a first powder, and a second powder dispenser for dispensing a second powder. The powder may have similar sintering temperatures. The powder dispensing mechanism may be configured to dispense first powder from the first powder dispenser to form in an outer shell, and to dispense second powder form the second powder dispenser to form an inner volume within the outer shell on the build plate.

The first powder may be more expensive than the second powder. In this manner, the formed objected may have the harder wear and desirable properties of the first powder, while being filled with the cheaper second powder thereby reducing costs. This could be achieved for more than two dispensers, e.g., six (6) dispensers. Further this could include a variety of fine and broad dispenser nozzles.

The powder dispensing mechanism may comprise a multi nozzle assembly. The multi nozzle assembly comprises a column assembly adapted to move a dispenser between a printing position or a storage position. In the printing position the dispenser is able to access the cavity in order to dispense powder to form one or more layers of an object. In the storage position the dispenser is not able to access the cavity. The column assembly may be remotely controlled to move a dispenser between the printing and storage positions. The column assembly may be adapted to move locate dispensers, e.g. six (6) dispensers, between printing and storage positions. Thus, the column assembly may move one dispenser into the printing position for dispensing powder while all other dispensers are in their storage positions. Once dispensing of the particular powder is complete, the dispenser may be moved into its storage position, and another dispenser may be moved to a printing position for dispensing powder. In this manner accidental release of powder is prevented.

The dispenser may be one of the support and build powder dispensers.

The powder dispensing mechanism may be mounted on a support frame. The support frame may surround the open end of the cavity. The support frame may be mounted on the side walls of the furnace.

The powder dispensing mechanism may be configured to move in the x and y axes on the support frame.

The furnace may further comprise:
an extruder hopper for storing build material to be dispensed by the powder dispensing mechanism, and optionally further comprising:
a main hopper for storing build material to refill the extruder hopper.

The furnace may comprise a plurality of extruder hoppers. Each extruder hopper may be associated with a dispenser for dispensing a powder on to the build plate to form an object.

The powder dispensing mechanism may further comprise one or more extruder hopper for storing build material to be dispensed by the dispenser. The mechanism may comprise a plurality of dispensers. The mechanism may comprise a plurality of extruder hopper, each extruder hopper associated with a respective dispenser.

The mechanism may further comprise a main hopper storing build material. The main hopper may be configured to refill one or more extruder hopper with build material.

The furnace may further comprise one or more sensors for detecting a parameter of one or more of the extruder hoppers. The main hopper may be controlled to refill one of the extruder hoppers based on the detected parameter. The parameter may be a weight of one or more of the extruder hoppers. The sensors may comprise weight sensors, pressure sensors, resistivity sensors, and vibrations sensors. The main hopper may be configured to dispense build material into one or more of the extruder hoppers based on the parameter reaching or being less than a threshold.

The furnace may further comprise a controller for controlling one or more of the build plate, powder dispensing mechanism, and thermal elements. The controller may be accessible remote from the furnace via the Internet, for example. The controller may receive inputs from one or more sensors such as temperature sensors located in the cavity or at the thermal elements.

According to another aspect there is provided of operating a dispensing mechanism, e.g., a powder dispensing mechanism, for forming an object to be sintered, the method comprising:
dispensing a layer of build material, e.g., powder, from an extruder hopper of the dispensing mechanism on to a build plate;
moving a build plate subsequent to the dispensing;
detecting a parameter of the extruder hopper subsequent to the dispensing; and
based on the detected parameter, refilling the extruder hopper from a main hopper storing build material.

Moving the build plate may comprise lowering the build plate within a cavity defined by a body of a furnace.

The parameter may comprise a weight of the build material, e.g., powder, in the extruder hopper.

The method may further comprise:
moving one of the extruder hopper and main hopper prior to refilling the extruder hopper from the main hopper.

The method may further comprise:
detecting the parameter of the extruder hopper subsequent to the refilling.

According to another aspect a method of manufacturing an object via additive manufacturing is provided.

The method may comprise:
obtaining an electronic file representing a geometry of an object; and
controlling the described furnace to manufacture, over one or more additive manufacturing steps, the object according to the geometry specified in the electronic file.

According to another aspect a computer program comprising computer executable instructions that, when executed by a processor, cause the processor to control the described furnace to manufacture an object.

According to another aspect a method of manufacturing an object via additive manufacturing is provided.

The method may comprise:
obtaining an electronic file representing a geometry of a product wherein the product is an object to be manufactured; and
controlling the described furnace to manufacture, over one or more additive manufacturing steps, the product according to the geometry specified in the electronic file.

Additive manufacturing processes typically fabricate an object based on three-dimensional (3D) information, for example a three-dimensional computer model (or design file), of the object.

The structure of an object may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any three-dimensional object to be fabricated on any additive manufacturing printer.

Further examples of design file formats include AutoCAD (.dwg) files, Blender (.blend) files, Parasolid (.x_t) files, 3D Manufacturing Format (.3mf) files, Autodesk (3ds) files, Collada (.dae) files and Wavefront (.obj) files, although many other file formats exist.

Design files can be produced using modelling (e.g. CAD modelling) software and/or through scanning the surface of a product to measure the surface configuration of the product.

Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process.

The code or instructions may be translated between different formats, converted into a set of data signals and transmitted, received as a set of data signals and converted to code, stored, etc., as necessary. The instructions may be an input to any of the described furnaces, computer readable medium or programs and may come from a part designer, an intellectual property (IP) provider, a design company, the operator or owner of the furnace, or from other sources. The instructions may be executed to fabricate the product.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system, e.g. the described furnace. For example, the instructions may include a precisely defined 3D model of the product and can be generated from any of a large variety of well-known computer aided design (CAD) software systems such as AutoCAD®, TurboCAD®, DesignCAD 3D Max, etc. Alternatively, a model or prototype of the component may be scanned to determine the three-dimensional information of the component.

Accordingly, by controlling an additive manufacturing apparatus, e.g. the described furnace, according to the computer executable instructions, the additive manufacturing apparatus can be instructed to print out one or more parts of a product. These can be printed either in assembled or unassembled form. For instance, different sections of the product may be printed separately (as a kit of unassembled parts) and then subsequently assembled. Alternatively, the different parts may be printed in assembled form.

In light of the above, embodiments include methods of manufacture via additive manufacturing. This includes the steps of obtaining a design file representing the product and instructing the described furnace to manufacture the product in assembled or unassembled form according to the design file. The furnace may include a processor that is configured to automatically convert the design file into computer executable instructions for controlling the manufacture of the product. In these embodiments, the design file itself can automatically cause the production of the product once input into the furnace. Accordingly, in this embodiment, the design file itself may be considered computer executable instructions that cause the furnace to manufacture the product. Alternatively, the design file may be converted into instructions by an external computing system, with the resulting computer executable instructions being provided to the furnace.

Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Any one or more of the described design, CAD files, etc. may form the described electronic file.

Features, benefits, or advantages associated with particular examples or embodiments relating to the described method may equally relate to the furnace and vice versa.

Further elements of the aspects described may include one or more examples, embodiments or features in isolation or in various combinations whether or not specifically stated (including claimed) in that combination or in isolation.

### BRIEF DESCRIPTION OF THE DRAWINGS

These and other aspects of the present disclosure will now be described, by way of example only, with reference to the accompanying Figures, in which:

FIG. 1 is a perspective view of a furnace in accordance with an aspect of the disclosure;

FIG. 2 is a front elevation view of the furnace of FIG. 1;

FIG. 3 is a cross-sectional side elevation view of the furnace of FIG. 1;

FIG. 4 is another perspective view of a furnace in accordance with an aspect of the disclosure;

FIG. 5 is a perspective view of a movement mechanism of a furnace in accordance with an aspect of the disclosure;

FIG. 6 is a front elevation view of the movement mechanism of FIG. 5;

FIG. 7 is a cross-sectional side elevation view of the movement mechanism of FIG. 5;

FIG. 8 is a perspective view of a powder dispensing mechanism of a furnace in accordance with an aspect of the disclosure;

FIG. 9 is another perspective view of the powder dispensing mechanism of FIG. 8;

FIG. 10 is a front elevation view of the powder dispensing mechanism of FIG. 8;

FIG. 11 is a flowchart of a method of forming an object by additive manufacturing within a furnace in accordance with an aspect of the disclosure;

FIGS. 12a-12c are front elevation cutaway views of an object being formed in a furnace in accordance with an aspect of the disclosure;

FIG. 13 is a perspective view of another furnace in accordance with an aspect of the disclosure;

FIG. 14 is a front elevation cutaway view of the furnace of FIG. 13;

FIG. 15 is a front elevation view of another powder dispensing mechanism of a furnace in accordance with an aspect of the disclosure;

FIG. 16 is a perspective view of a portion of the powder dispensing mechanism of FIG. 15; and

FIG. 17 is a flowchart of a method of operating the powder dispensing mechanism of FIG. 15.

### DETAILED DESCRIPTION

The foregoing summary, as well as the following detailed description of certain embodiments will be better understood when read in conjunction with the accompanying drawings. As will be appreciated, like reference characters are used to refer to like elements throughout the description and drawings. As used herein, an element or feature recited in the singular and preceded by the word “a” or “an” should be understood as not necessarily excluding a plural of the elements or features. Further, references to “one example” or “one embodiment” are not intended to be interpreted as excluding the existence of additional examples or embodiments that also incorporate the recited elements or features of that one example or one embodiment. Moreover, unless explicitly stated to the contrary, examples or embodiments “comprising”, “having” or “including” an element or feature or a plurality of elements or features having a particular property might further include additional elements or features not having that particular property. Also, it will be appreciated that the terms “comprises”, “has” and “includes” mean “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of describing the relationship of an element or feature to another element or feature as depicted in the figures. The spatially relative terms can however, encompass different orientations in use or operation in addition to the orientation depicted in the figures.

Reference herein to “example” means that one or more feature, structure, element, component, characteristic and/or operational step described in connection with the example is included in at least one embodiment and or implementation of the subject matter according to the present disclosure. Thus, the phrases “an example,” “another example,” and similar language throughout the present disclosure may, but do not necessarily, refer to the same example. Further, the subject matter characterizing any one example may, but does not necessarily, include the subject matter characterizing any other example.

Reference herein to “configured” denotes an actual state of configuration that fundamentally ties the element or feature to the physical characteristics of the element or feature preceding the phrase “configured to”.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within less than 10% of, within less than 5% of, within less than 1% of, within less than 0.1% of, or within less than 0.01% of the stated amount.

Aspects of the present disclosure relate to a furnace for additive manufacturing, and a method forming an object by additive manufacturing within a furnace. An object may be formed via powder dispensers in the furnace and heat treated in the same furnace thereby reducing risk of damage caused by moving the object between a printing apparatus and a heat treating or sintering apparatus. Further an object heat treated after forming without movement may have improved physical properties and characteristics over an object formed in the conventional manner.

It should be understood that the drawings presented are not to scale, and may not reflect actual dimensions, ratios, angles, numbers of features or the like.

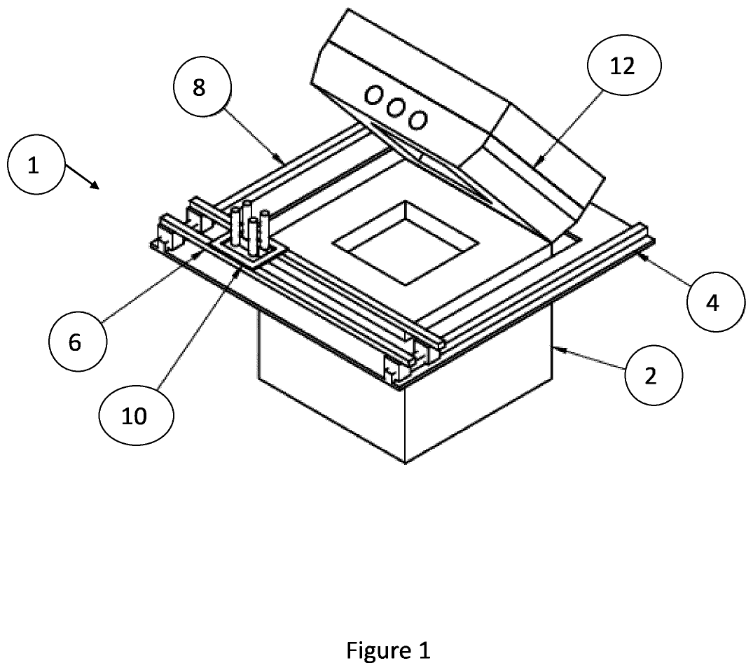

A furnace 1 is shown in FIGS. 1-4. The furnace 1 is used for manufacturing an object via additive manufacturing. The furnace 1 provides a location at which the object may be formed via powder dispensers, and then heat treated, e.g. sintered, without the object being moved between the forming and heat treating or sintering.

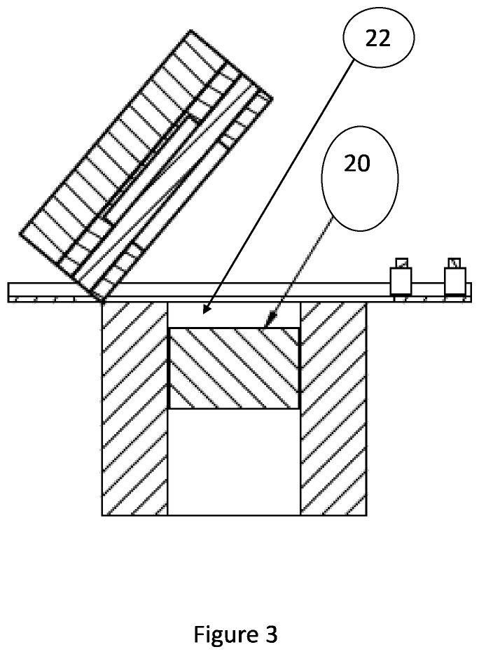

The furnace 1 comprises a main body 2 formed by four side walls. In this arrangement the main body 2 is generally rectangular. In another arrangement the main body 2 is generally cylindrical and formed by a single wall. The side walls define a cavity 22 as shown in FIG. 3. Thus the cavity 22 is internal to the main body 2 and side walls of the furnace 1. The cavity 22 is accessible via an open end and is bounded by side walls and a build plate 20. The build plate 20 is generally planar such that an object may be formed on the build plate 20 by powder dispensers. In the illustrated arrangement the build plate 20 is generally square or rectangle, but other shapes are possible. For example, the build plate 20 may take the form of a disc. The side wall or walls are correspondingly adapted.

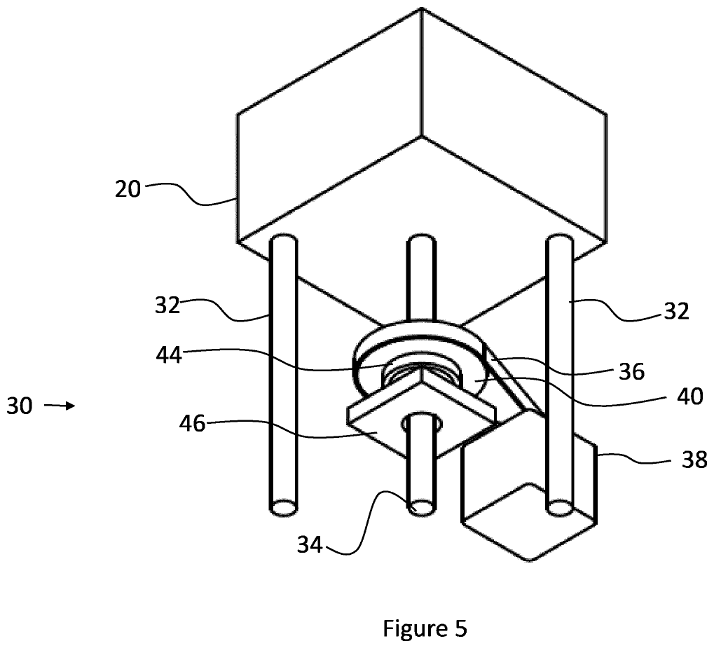

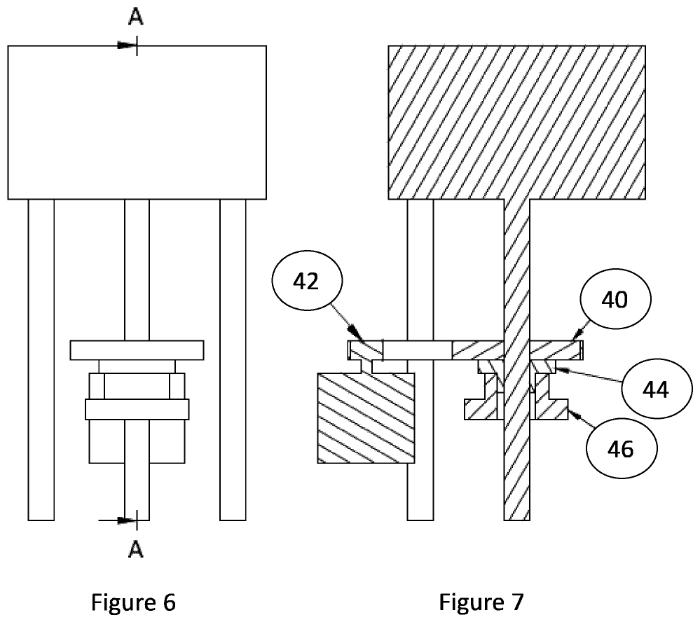

The build plate 20 is moveable within the cavity 22. In this arrangement the build plate 20 may be raised and lowered in the z axis. The build plate 20 is moveable from a raised position to a lowered position as powder is dispensed onto the build plate 20 form an object. A movement mechanism 30 is adapted to move the build plate 20 as will described with reference to FIGS. 5-7.

The furnace 1 further comprises a powder dispensing mechanism 10 from which powder may be dispensed to form an object on the build plate 20 via additive manufacturing. The powder dispensing mechanism 10 is moveable in the x axis and in the y axis such that powder may be dispensed in any x-y location on the build plate 20. Further raised and lowering the build plate 20 allows for powder to be dispensed in any x-y-z location in the cavity 22.

The powder dispensing mechanism 10 is mounted on a x axis linear mechanism 6 which is mounted on a y axis linear mechanism 8. The powder dispensing mechanism 10 is moveable on the mechanisms 6, 8 in the x and y plane. In the illustrated arrangement the mechanisms 6, 8 take the form of rails; however, one of skill in the art will appreciate other configurations are possible.

The mechanisms 6, 8 are mounted on a frame 4. The frame 4 supports the mechanisms 6, 8. The frame 4 is connected at a periphery of the main body 2 of the furnace 1. The frame 4 is connected to the main body 2 such that the powder dispensing mechanism 10 may access the cavity 22 through an open end thereof to dispense powder onto the build plate 20.

During dispensing of powder from the powder dispensing mechanism 10, the build plate 20 may be gradually lowered such that layers of an object may be formed on the build plate 20. Thus the layers formed in this manner may be generally vertical, i.e. formed in z axis.

The furnace 1 further comprises a lid 12 connected to the main body 2 of the furnace 1. In the illustrated arrangement the lid 12 is connected to a side wall of the furnace 1. The lid 12 is rotateable or pivotable with respect to the main body 2 of the furnace 1 to open or close. When closed, the lid 12 prevents access to the cavity 22 and may prevent heat from within the cavity from being released out of the cavity 22. The lid 12 may therefore prevent heat damage to components of the furnace 1 such as the powder dispensing mechanism 10.

In the illustrated arrangement, the lid 12 comprises an upper lid 16 and lower lid 14. The lower lid 14 is connected to the main body 2 of the furnace 1. In the illustrated arrangement the lower lid 14 is rotateable or pivotable with respect to the main body 2 of the furnace 1 to open or close. When closed, the lower lid 14 prevents access to the cavity 22 and to an object formed on the build plate 20. When the lower lid 14 is open, the cavity 22 and an object formed on the build plate 20 are accessible.

The upper lid 16 is connected to the lower lid 14. In the illustrated arrangement the upper lid 16 is rotateable or pivotable with respect to the lower lid 14. When closed, the upper lid 16 (in addition to the lower lid 14) prevents access to the cavity 22 and to an object formed on the build plate 20. When the upper lid 16 is open, the lower lid 14 is accessible.

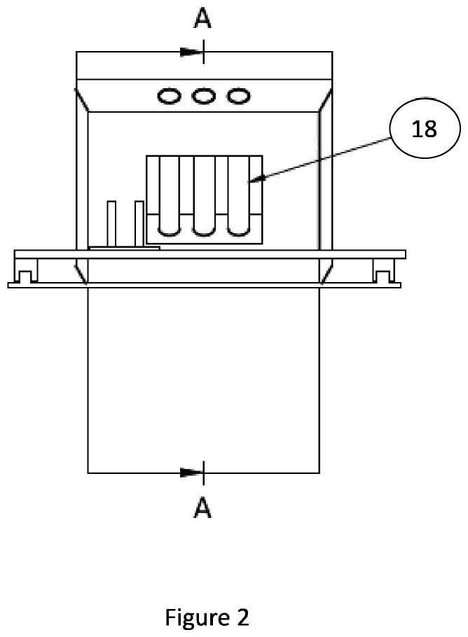

As shown in FIG. 2, thermal elements 18 are positioned within the lower lid 14. The thermal elements 18 comprise resistive elements for heat treating or sintering an objected formed on the build plate 20. In particular the thermal elements 18 are adapted to sinter the objected formed on the build plate 20. As shown in FIG. 2 the thermal elements 18 are contained within the lower lid 14 such that the thermal elements 18 are enclosed by are generally centrally locate within the lower lid 14.

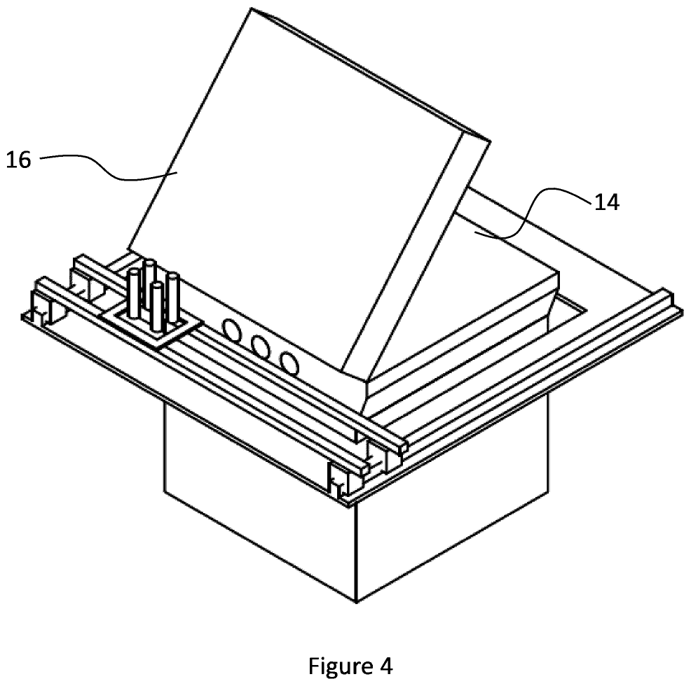

In FIGS. 1-3 the lid 12 is open. In FIG. 4, the upper lid 16 is open and the lower lid 14 is closed. When the lower lid 14 (or both lids 14, 16 are closed) the cavity 22 cannot be accessed by an operator or by the powder dispensing mechanism 10.

When the lower lid 14 is closed, the thermal elements 18 are in position to sinter the object formed on the build plate 20. The upper lid 16 is also closed to contain heat applied to the object within the cavity 22. The upper lid 16 may comprise insulation to contain heat within the cavity 22. Once heat treatment or sintering is complete, the upper lid 16 is opened and heat is released from the cavity 22. As shown in FIG. 4, the upper lid 16 opens away from the powder dispensing mechanism 10. Thus heat released from the cavity 22 is directed away from the powder dispensing mechanism 10. The manner in which the upper lid 16 opens away from the powder dispensing mechanism 10 ensures the powder dispensing mechanism 10 is not damaged by released heat.

In use the lids 14, 16 are opened such that the cavity 22 and build plate 20 are accessible to the powder dispensing mechanism 10. The powder dispensing mechanism 10 then moves along the x and y axis linear mechanisms 6, 8 to dispense powder on the build plate 20. In particular, the powder dispensing mechanism 10 dispenses a support powder to form base layer of the object on the build plate 20. The powder dispensing mechanism 10 then dispenses powder to form one of more layers on the base layer on the build plate 20. The powder dispensing mechanism 10 may move in the x and y axes via the linear mechanisms to dispense powder and form the object in any three-dimensional shape or configuration. Further as the powder dispensing mechanism 10 is dispensing powder, the build plate 20 may lower in the z axis. Once the object has been formed, the powder dispensing mechanism 10 is moved by the mechanisms 6, 8 such that the lids 14, 16 may close. The thermal elements 18 are then activated to heat treat/sinter the object. The upper lid 16 is then opened to release heat from the cavity 22. Once sufficient heat is released, the lower lid 14 is opened, and the heat treated/sintered object may be removed from the cavity 22.

While not shown in FIG. 1-4, the furnace 1 may additionally comprise a controller for controlling operation of any one of the powder dispensing mechanism 10, the linear mechanisms 6, 8, the build plate 20, thermal elements 18, and the lid 12 (lower and upper lids 14, 16). The controller may include sensors, detectors or similar for feedback back information involved in the control of the aforementioned elements.

The furnace 1 may further comprise an interface for operating the controller. The interface may be used to directly operate the noted elements. For example the interface may take the form of a touch screen panel on the furnace for controlling operation of the thermal elements 18 once the upper and lower lids 16, 14 are closed. The interface may be remotely located from the furnace 1 and may be accessible via LAN/WLAN or other communication schemes. The interface may accessible via a software browser interface via the Internet. The interface may provide for remote operation of the furnace 1 as well as remote monitoring of conditions at the furnace 1 such as temperature, pressure, powder, resistance, etc.

The furnace 1 may further include a fan (not shown) for drawing heat from the cavity 22. The fan may be located within the cavity 22 for directing heat out of the cavity 22 during heat treating/sintering.

Turning now to FIGS. 5-7, the build plate 20 is shown in more detail. As previously stated powder is dispensed on the build plate 20 to form the object. The build plate 20 is moveable in the z axis. That is the build plate 20 may be raised or lowered within the cavity 22. Lowering the cavity 22 with respect to the open end of the cavity 22 may allow for layers of powder to be dispensed to form an object to a desired height.

The furnace 1 comprises a movement mechanism 30 for moving the build plate 20 in the z axis. In the illustrated arrangement the movement mechanism 30 takes the form of a threaded rod arrangement driven by a pulley assembly driven by a motor. The movement mechanism 30 comprises rods 32 affixed to the build plate 20. In the illustrated arrangement the movement mechanism 30 comprises two rods 32 affixed on opposite corners of the build plate 20. One of skill in the art will appreciate that more or less rods 32 may be present. The rods 32 provide stability to the build plate 20 as it is raised and lowered ensuring a stable surface for dispensing powder on. While not show in the Figures each rod 32 runs through a double set of bushings to build plate 20 moves in the z axis up and down smoothly and precisely.

The movement mechanism 30 further comprises a threaded rod 34 connected to the build plate 20. The threaded rod 34 is centrally located within the build plate 20. A first timing pulley 40 is mounted on the threaded rod 34 and affixed to a threaded nut 44 for raising/lowering the build plate 20. A bearing block 46 is mounted on the threaded rod 34 opposite the first timing pulley 40 with respect to the threaded nut 44 to prevent the build plate 20 from uncontrolled lowering. A timing belt 36 is mounted on the first timing pulley 40 and a second timing pulley 42 which is connected to a motor 38.

Upon actuation of the motor 38, rotation of the motor 38 is translated through the second timing belt 42 via the timing belt 36 to the first timing pulley 40. Rotation of the first timing pulley 40 causes rotation of nut 44 to raise or lower to the build plate 20 depending on the direction of rotation of the motor 38.

The motor 38 may be connected to the previously described controller such that dispensing of powder from the powder dispensing mechanism 10 is coordinating with lowering/raising of the build plate 20.

While a particular movement mechanism 30 is described, one of skill in the art will appreciate that other configurations are possible. In another arrangement the movement mechanism comprises one or more hydraulic arms or lifts for raising or lowering the build plate 20.

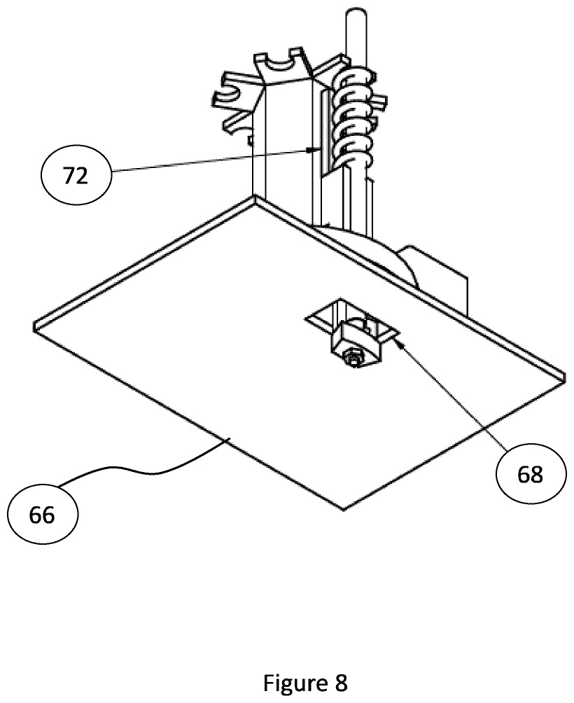

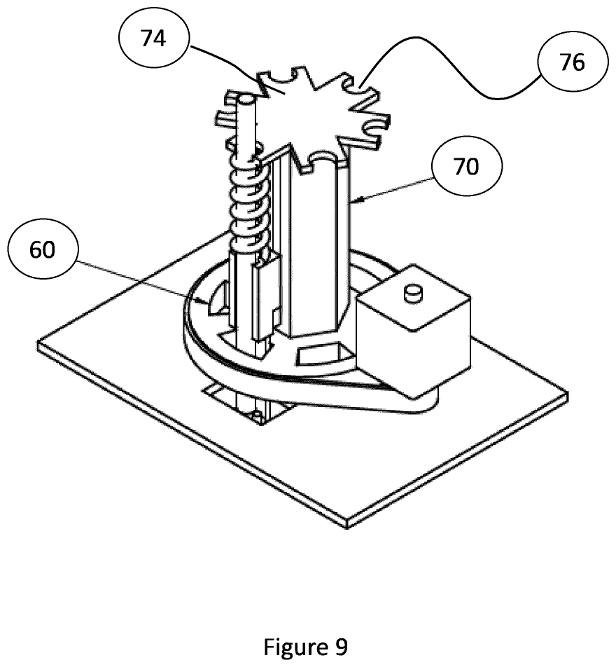

Turning now to FIGS. 8-10, the powdering dispensing mechanism 10 is shown in more detail. The powder dispensing mechanism 10 may be controlled by the controller. In particular, the controller may control the via numerical control. As such the powder dispensing mechanism 10, controller may form part of a computer numerical control (CNC) machine. The thermal elements may additionally form part of the CNC machine.

The powder dispensing mechanism 10 comprises dispensers for both detail and broad powder dispensing, and dispensers for dispensing powder of a variety of materials such as metal. Metal powder may include stainless steel, tool steel, Inconel™, nickel alloys, titanium, copper, brass, gold, silver, platinum, and combinations thereof.

The powder which forms one or more layers on the base layer may be a metal powder. This powder, metal or not, may have a lower melting point, or lower rate of thermal conductivity than the powder which is used to form the base layer.

The powder dispensing mechanism 10 may comprise multiple dispensers which dispense particular powder. For example the powder dispensing mechanism 10 may comprise a support powder dispenser which dispenses powder to form a base layer of an object on the build plate 20, and a build powder dispenser that dispenses powder to form one or more layers on the base layer on the build plate 20. Thus the powder dispensing mechanism 10 may be arranged to accommodate multiple dispensers. The powder dispensing mechanism 10 may thus form a multi nozzle assembly.

As illustrated in FIGS. 8-10, the powder dispensing mechanism 10 comprises a column assembly 70 arranged above a support plate 66 having an aperture 68. The column assembly 70 is adapted to hold multiple dispensers and is controlled to move one of the dispensers between a stored position to a printing position. In the printing position a dispenser projects through the aperture 68 in the support plate 66 to dispenser powder into the cavity 22 and onto the build plate 20, or base layer formed on the build plate 20.

In the illustrated arrangement the column assembly 70 is adapted to hold six (6) dispensers fitted around a central column. The column assembly 70 comprises a column head 74 having six (6) slots 76 therein. Each slot 76 accommodates a single dispenser. Each dispenser is fitted into a particular slot 76 and mounted on a respective linear rail mechanism 72 which is controlled to raise or lower the dispenser to move the dispenser between the storage and printing positions. The column assembly 70 accordingly comprises six (6) linear rail mechanisms 72 mounted on the central column with each linear rail mechanism 72 aligned with a respective slot 76.

While the column assembly 70 has been described as accommodating six (6) dispensers more or fewer may be present. Additionally, the column assembly 70 may be adapted to accommodate more or fewer dispensers.

In the illustrated arrangement a dispenser comprises a hose 50 which provides powder to be dispensed from the nozzle 64. The powder may be provided from a reservoir (not shown). The dispenser further comprises a spring 52 which is under compression to spring load the dispenser in the storage positon. In this manner the dispenser may be quickly moved into the printing position to ensure powder is not raised and an object may be formed with precision and accuracy. A nozzle 64 is located an end of the hose 50 through which powder is dispensed. The nozzle 64 is fixed to a nozzle block 62 which contains a vibration motor for actuating dispensation of powder from the nozzle 64.

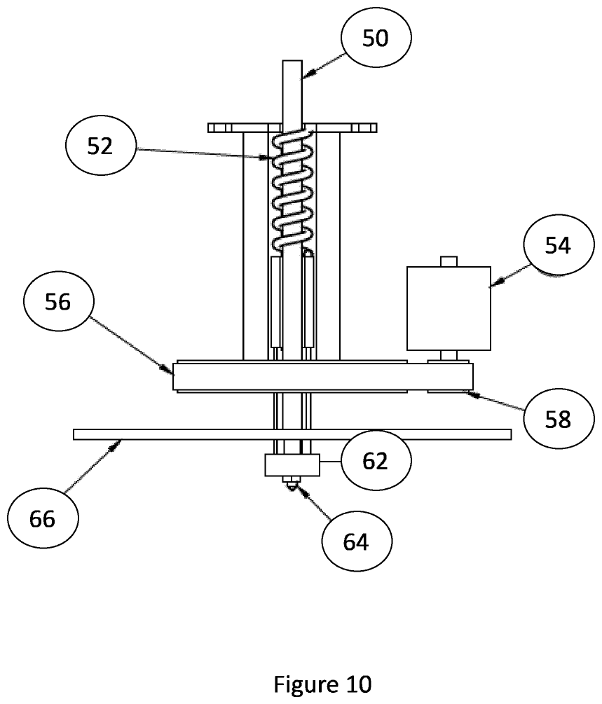

As shown in FIG. 10, in the printing position, the nozzle 64 and nozzle block 62 project through the aperture 68 in the support plate 66 such that powder may be dispensed onto the build plate 20, or base layer formed on the build plate 20. When the particular dispenser is no longer needed, the dispenser is retracted via the linear rail mechanism, and the nozzle 64 and nozzle block 62 no longer project through the aperture 68. The column assembly 70 may then be rotated to select an alternate dispenser for dispensing powder. This ensures a dispenser does not accidentally dispense or release powder in the cavity 22.

The column assembly 70 is rotated via a motor 54 affixed to a first timing pulley 58. A timing belt 58 is mounted on the first timing pulley 58 and a second timing pulley 56 which is affixed to the column assembly 70. Upon actuation of the motor 54, the timing pulleys 58, 56 rotate to column assembly 70 via the timing belt 58 to align a selected dispenser with the aperture 68 in the support plate 66. The selected dispenser may then be lowered to project the nozzle 64 and nozzle block 62 of the selected dispenser through the aperture 68.

For example, the column assembly 70 may be rotated until a support powder dispenser which dispenses a support powder is aligned with the aperture 68. The selected support powder dispenser may be then be lowered to a printing position such that the nozzle 64 and nozzle block 62 project through the aperture 68. The support powder dispenser may then dispense powder to form a base layer on the build plate 20. Once the base layer is formed, the support powder dispenser may be raised to a storage position such that the nozzle 64 and nozzle block 62 of the support powder dispenser no longer project through the aperture 68. The column assembly 70 may then be rotated until a build powder dispenser which dispensers powder to form one or more layers on the base layer is aligned with the aperture 68. The selected build powder dispenser may then be lowered to a printing position such that the nozzle 64 and nozzle block 62 project through the aperture 68. The build powder dispenser may then dispense powder to form one or more layers on the base layer on the build plate 20. Once the desired object is formed, the build powder dispenser may be raised to a storage position such that the nozzle 64 and nozzle block 62 of the build powder dispenser no longer project through the aperture 68.

The lids 14, 16 of the furnace 1 may then be closed and the thermal elements actuated to heat treat/sinter the formed object. Once sintering is complete, the upper lid 16 may be opened to release heat from the cavity 22. Once sufficient heat is released from the cavity 22, the lower lid 14 may be opened and the heat treated object may be removed from the cavity 22. In this manner an object may be formed and heat treated without requiring any movement between apparatus. This may reduce the risk of damage to the object, improve the objects physical properties, and reduce costs and time associated with forming the object via additive manufacturing.

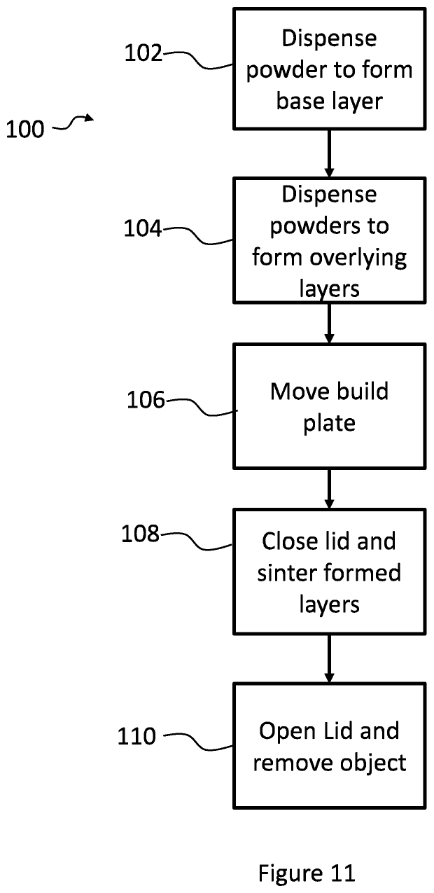

Turning now to FIG. 11, a flowchart of a method 100 of forming an object by additive manufacturing within a furnace is illustrated. The method 100 comprises dispensing 102 powder to form a base layer on the build plate 20 of the furnace 1. The dispensing 102 may include selecting a support powder dispenser and moving the support powder dispenser into a printing position as described. The powder may be referred to as a base powder.

The method 110 further comprises dispensing 104 powder to form one or more layers on the base layer. The layers overlay the base layer. The powder may be metal powder. Dispensing 104 powder to form the one or more layer may comprise dispensing powder from more than one dispenser. For example, the dispensing 104 may include dispensing powder via a fine metal nozzle from a particular dispenser to trace an outline of the object, and the dispensing powder via a broad metal nozzle from another different dispenser to fill the interior of the object. The dispensers may be raised and lowered, and the column assembly 70 may be rotated as described.

A fine or detail nozzle may be under 2 mm in diameter. A broad nozzle may be above 2 mm in diameter.

During, between or after the dispensing 102, 104, the build plate 20 may be lowered 106 in the z axis to achieve the desired vertical location. For example, after dispensing 102 base powder to form the base layer, the build plate 20 may be lowered a height of the base layer to accommodate forming of additional layers.

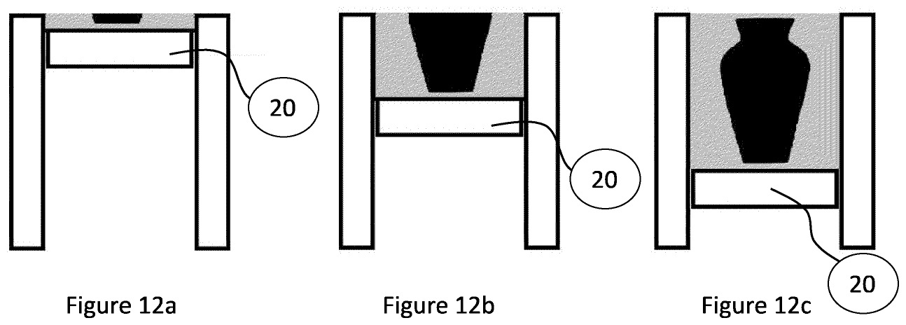

As shown in FIGS. 12a-12c, the build plate 20 is lowered 106 in the z-axis as powder is dispensed 102 to form the build layer, and additionally as powder is dispensed to form one or more additional layers on the base layer. The dispensing 104, 106 forms the object on the base plate 20 as the base plate is lowered 106. In this way, lowering 106 of the base plate 20 allows the height of the object being formed to increase, and the object to be formed within the cavity 22 of the furnace 1.

Dispensing 104 to form an outline of the object and/or to fill in the outline of the object, and lowering 106 the build plate 20 may be repeated until the object is formed. Once the object is formed, the lid 12, i.e. the upper and lower lids 16, 14, is closed and the formed layers are sintered 108. Sintering 108 comprises activating the thermal elements 18 in the lower lid 14 to heat treat the formed layers. Sintering 108 may comprise a cycle of heating the formed layers in the cavity 22 via the thermal elements 18, holding the temperature at a particular level, and then cooling the cavity 22. A temperature sensor in the cavity 22 may be used to detect a temperature in the cavity 22 and may be used by a controller to control the thermal elements 18.

Prior to sintering 108 the build plate 20 may be raised or lowered to a particular set height suitable for sintering 108. For example, the build plate 20 may be lowered to its lowest point.

Once the formed layer have been sintered 108, the object may be removed 110 from the cavity 22. This may include opening the upper lid 16 to release heat from the cavity 22 without damaging components of the furnace 1. The lower lid 14 may then be opened when sufficient heat has been released from the cavity 22. The object may then be removed 110 from the cavity 22. Removing 110 the object may further comprise removing the object from the base layer which functions as a support material for the object during the printing process.

Prior to dispensing 102 the powder to form a base layer, all of the axes of the powder dispensing mechanism 10 may be zeroed. Additionally, the build plate 20 may be raised to an appropriate height to form an initial base layer.

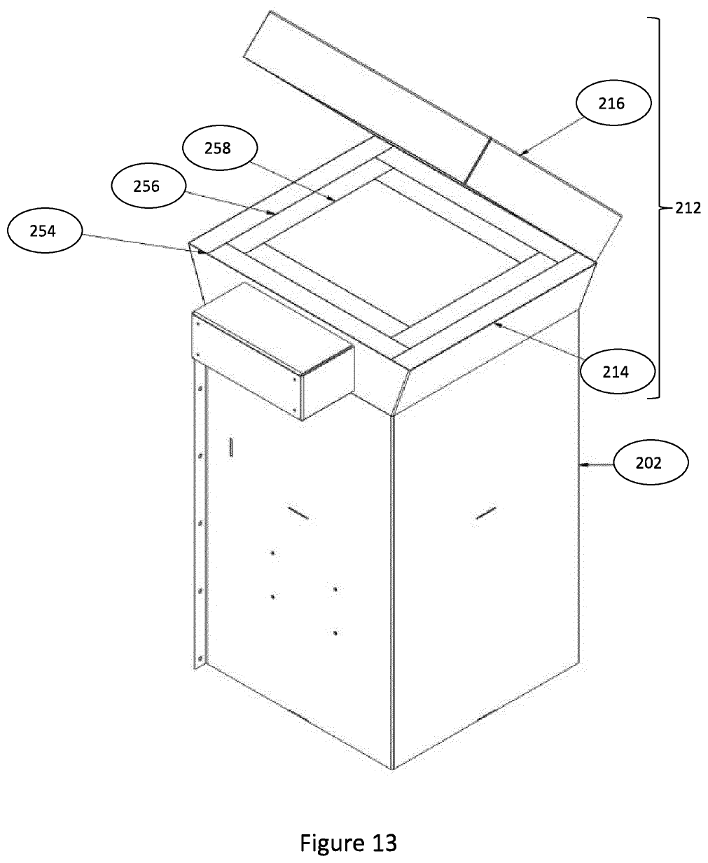

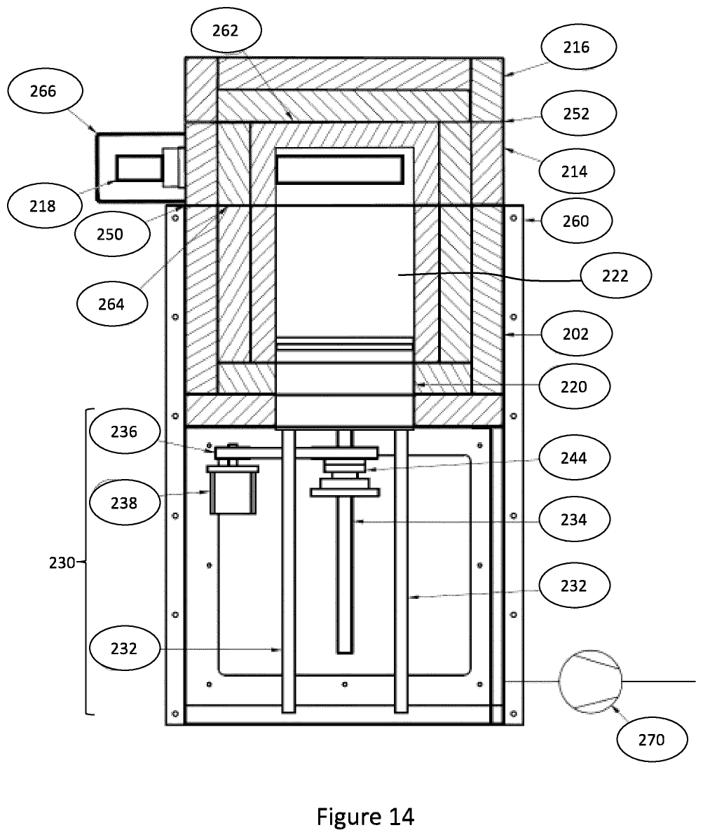

While a particular furnace 1 has been described, one of skill in the art would appreciate other configurations are possible. Turning to FIG. 13 and 14, another embodiment of a furnace 200 in accordance with as aspect of the disclosure is illustrated. The furnace 200 may be used for manufacturing an object via additive manufacturing. The furnace 200 provides a location at which the object may be formed via powder dispensers, and then heat treated, e.g. sintered, without the object being moved to another location from where it has been formed between the forming and heat treating or sintering.

The furnace 200 comprises a main body 202 formed by four side walls. In this arrangement the main body 202 is generally rectangular. In another arrangement the main body 202 is generally cylindrical and formed by a single wall. As shown in FIG. 14, the main body 202 includes a flange 260 which, in the illustrated arrangement, includes an atmospheric seal. Such an arrangement retains heat within the main body 202 during heating/sintering of an object within the furnace.

The side walls define a cavity 222 as shown in FIG. 14. Thus the cavity 222 is internal to the main body 202 and side walls of the furnace 200. The cavity 222 is accessible via an open end and is bounded by side walls and a build plate 220. The build plate 220 is generally planar such that an object may be formed on the build plate 220 by powder dispensers. In the illustrated arrangement, the build plate 220 is generally square or rectangle, but other shapes are possible. For example, the build plate 220 may take the form of a disc. The side wall or walls are correspondingly adapted.

The build plate 220 is moveable within the cavity 222. In this arrangement the build plate 220 may be raised and lowered in the z axis. The build plate 220 is moveable from a raised position to a lowered position as powder is dispensed onto the build plate 220 form an object. A movement mechanism 230 is adapted to move the build plate 220 as will described.

The furnace 200 further comprises a powder dispensing mechanism 210 from which powder may be dispensed to form an object on the build plate 220 via additive manufacturing. The powder dispensing mechanism 210 is moveable in the x axis and in the y axis such that powder may be dispensed in any x-y location on the build plate 220. Further raised and lowering the build plate 220 allows for powder to be dispensed in any x-y-z location in the cavity 222. The powder dispensing mechanism 210 will be described in further detail below.

The furnace 200 further comprises a lid 212 connected to the main body 202 of the furnace 200. In the illustrated arrangement the lid 212 is connected to a side wall of the furnace 200. The lid 212 is rotateable or pivotable with respect to the main body 202 of the furnace 200 to open or close. When closed, the lid 212 prevents access to the cavity 222 and may prevent heat from within the cavity from being released out of the cavity 222. The lid 212 may therefore prevent heat damage to components of the furnace 200.

In the illustrated arrangement, the lid 212 comprises an upper lid 216 and lower lid 214. The lower lid 214 is connected to the main body 202 of the furnace 200. In the illustrated arrangement the lower lid 214 is rotateable or pivotable with respect to the main body 202 of the furnace 200 to open or close about lower lid hinge point 250. When closed, the lower lid 214 prevents access to the cavity 222 and to an object formed on the build plate 220. When the lower lid 214 is open, the cavity 222 and an object formed on the build plate 220 are accessible.

The upper lid 216 is connected to the lower lid 214. In the illustrated arrangement the upper lid 216 is rotateable or pivotable with respect to the lower lid 214 about upper lid hinge point 252. When closed, the upper lid 216 (in addition to the lower lid 214) prevents access to the cavity 222 and to an object formed on the build plate 220. When the upper lid 216 is open, the lower lid 214 is accessible. As shown in FIG. 14, the hinge points 250, 252 are opposing edges of the body 202 of the furnace 200. In this way, the upper lid 216 opens in a first rotary direction, e.g., clockwise, while the lower lid 216 opens in a second rotary direction, opposite the first rotary direction, e.g., counter-clockwise.

The lower lid 214 comprises an outer layer of insulation 254, an inner layer of insulation 256, and refractory material 258. The inner layer of insulation 256 is positioned between the outer layer of insulation 254 and the refractory material 258. As one of skill in the art will appreciate a variety of insulations and refractory material may be used.

While not shown, the upper lid 216 also comprises refractory material and/or insulation. The insulation and/or refractory material in the upper lid 216 has a lower rate of heat transfer than the insulation and/or refractory material in the lower lid 214. The higher rate of heat transfer in the lower lid 214 allows for heat to escape the cavity 222 when the lower lid 214 is closed, but the upper lid 216 is open. However, when the lower lid 214 and the upper lid 216 are both closed, heat is retained within the cavity 222.

This allows for the object within the cavity 222 to be sintered within the cavity 222 without exposure to atmosphere. However, when sintering is complete, the upper lid 216 is opened and the object may cool while still being protected from atmosphere by the lower lid 214.

When the upper lid 216 is closed, the upper lid 216 forms an atmospheric seal 262 sealing the lower lid 214 and cavity 222 from the external environment. However, when the lower lid 214 is closed and the upper lid 216 is open, heat inside the cavity 22 may be still be removed in a controlled manner due to differences in the insulation and refractory materials present in the lower lid 214 and the upper lid 216. When the lower lid 214 is closed, the lower lid 214 forms an atmospheric seal 264 sealing the cavity 222. The seals 262, 264 may be formed by a sealing member, e.g., a rubber seal.

As shown in FIG. 14, the furnace 200 additionally comprises thermal elements 218 generally positioned within the lower lid 214. In the illustrated arrangement, the thermals elements 218 resistive elements for heat treating or sintering an objected formed on the build plate 220. In particular the thermal elements 218 are adapted to sinter the objected formed on the build plate 220. As shown in FIG. 14, the thermal elements 218 extend through the lower lid 214 such that a portion of the elements 218 are external to the lid 214.

The portion of the thermal elements 218 external to the lid 214 is enclosed within a cover 266 affixed to the lower lid 214. The cover 266 is removable to allow for maintenance and/or replacement of one or more of the thermal elements 218. The cover 266 may be insulated to prevent heat loss. Additionally the cover 266 may be sealed to prevent atmospheric exposure.

As described the furnace 200 comprises a movement mechanism 230 adapted to move the build plate 220. The movement mechanism 230 is for moving the build plate 220 in the z axis.

In the illustrated arrangement the movement mechanism 30 takes the form of a threaded rod arrangement driven by a pulley assembly driven by a motor. The movement mechanism 230 comprises rods 232 affixed to the build plate 220. In the illustrated arrangement the movement mechanism 230 comprises two rods 232 affixed on opposite corners of the build plate 220. One of skill in the art will appreciate that more or less rods 232 may be present. The rods 232 provide stability to the build plate 220 as it is raised and lowered ensuring a stable surface for dispensing powder on. While not show in the Figures each rod 232 runs through a double set of bushings to build plate 220 moves in the z axis up and down smoothly and precisely.

The movement mechanism 230 further comprises a threaded rod 234 connected to the build plate 220. The threaded rod 234 is centrally located within the build plate 220.

A pulley and belt 236 connected to a motor 238 is controlled to raise/lower the build plate 220. In the illustrated arrangement the pulley and belt 26 comprises, a first timing pulley mounted on the threaded rod 234 and affixed to a threaded nut 244 for raising/lowering the build plate 220. A bearing block is mounted on the threaded rod 234 opposite the first timing pulley with respect to the threaded nut 244 to prevent the build plate 220 from uncontrolled lowering. A timing belt off the pulley and belt 236 is mounted on the first timing pulley and a second timing pulley of the pulley/belt 236 which is connected to the motor 238.

Upon actuation of the motor 238, rotation of the motor 238 is translated through the second timing belt via the timing belt to the first timing pulley. Rotation of the first timing pulley causes rotation of nut 244 to raise or lower to the build plate 220 depending on the direction of rotation of the motor 238.

While a particular movement mechanism 230 is described, one of skill in the art will appreciate that other configurations are possible. In another arrangement the movement mechanism comprises one or more hydraulic arms or lifts for raising or lowering the build plate 220.

While not shown in the Figures, the furnace 200 may additionally comprise a controller for controlling operation of any one of the powder dispensing mechanism 210, the build plate 220, thermal elements 218, and the lid 212 (lower and upper lids 214, 216). The controller may include sensors, detectors or similar for feedback back information involved in the control of the aforementioned elements.

The furnace 200 may further comprise an interface for operating the controller. The interface may be used to directly operate the noted elements. For example the interface may take the form of a touch screen panel on the furnace 220 for controlling operation of the thermal elements 218 once the upper and lower lids 216, 214 are closed. The interface may be remotely located from the furnace 200 and may be accessible via LAN/WLAN or other communication schemes. The interface may accessible via a software browser interface via the Internet. The interface may provide for remote operation of the furnace 200 as well as remote monitoring of conditions at the furnace 200 such as temperature, pressure, powder, resistance, etc.

The motor 238 may be connected to a controller such that dispensing of powder from the powder dispensing mechanism 210 is coordinating with lowering/raising of the build plate 220.

The furnace 200 may further include a pump 270 for drawing heat from the cavity 222. The pump 270 is fluidly connected to the cavity 222 to draw from the cavity 222 to create a vacuum in the cavity 222. Alternatively, the pump 270 may pump an inert gas into the cavity 222. The cavity 222 is accordingly sealed via one or more sealing elements, e.g., rubber seals. The pump 270 may be connected to the cavity 222 along with a solenoid connection to control operation of the pump 270 for inert gas to be pumped into the cavity or to draw from the cavity to create a vacuum. The pump 270 is operated after powder has been deposited/dispensed, but before the thermal elements 218 are activated to sinter the object.

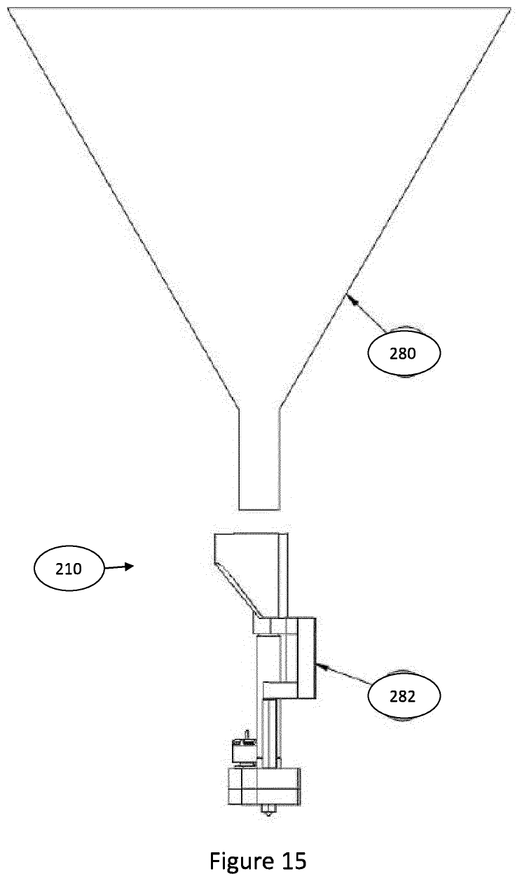

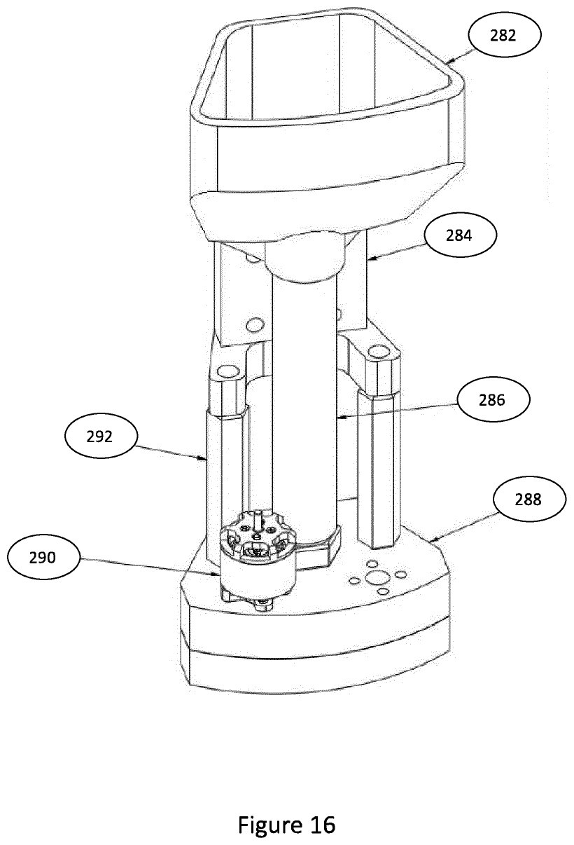

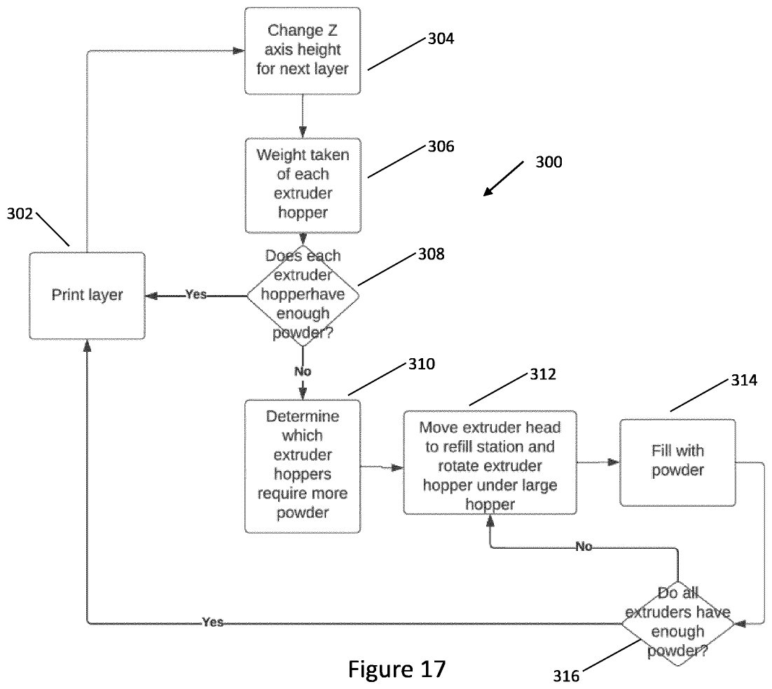

As previously-stated, the furnace 210 comprises a powder dispensing mechanism 210. The powder dispensing mechanism 210 is shown in more detail in FIGS. 15 and 16. Similar to the powder dispensing mechanism 10 of furnace 1, the powder dispensing mechanism 210 of furnace 200 is mounted on a x axis linear mechanism which is mounted on a y axis linear mechanism. The linear mechanisms are not illustrated in FIGS. 15 and 16 for clarity. The powder dispensing mechanism 210 is moveable on the linear mechanisms in the x and y plane.

The powder dispensing mechanism 210 comprises a column assembly with dispensers as described with reference to the furnace 1 and powder dispensing mechanism 10. For clarity these elements are not depicted in FIGS. 15 and 16. The column assembly and dispensers function in the manner already described. However, in this arrangement rather than the dispensers being fed by a hose, each dispensers may be fed from an extruder hopper 282 which in turn is fed by a main hopper 280.

The extruder hopper 282 feeds powder to be dispensed in small quantities. If the extruder hopper 282 is empty and more powder is required, the controller control release of powder from the main hopper 280 into the extruder hopper 282 to refill the extruder hopper 282 and allow more powder to be dispensed. This arrangement may prevent blocking of powder within the powder dispensing mechanism 210 thereby improving manufacture by reducing flaws in object manufacture and/or reducing build time.

A nozzle assembly 288 which includes a nozzle from which powder is dispensed is connected to the extruder hopper 282 via a tube 286. The extruder hopper 282 and tube 286 are mounted to the nozzle assembly 288 on a linear rail bracket 284. Standoffs 286 separate the bracket 284 and extruder hopper 282 from the nozzle assembly 288. The standoffs 286 isolate the elements to prevent vibration transfer between elements. The vibration motor 290 is used to dispense build material, e.g., powder, from the nozzle assembly 288.

When the lids 214, 216 are closed the cavity 222 cannot be accessed by an operator or by a powder dispensing mechanism 210.

When the lower lid 214 is closed, the thermal elements 218 are in position to sinter the object formed on the build plate 220. The upper lid 216 is also closed to contain heat applied to the object within the cavity 222. The upper lid 216 may comprise insulation to contain heat within the cavity 222. Once heat treatment or sintering is complete, the upper lid 216 is opened and heat is released from the cavity 222.

As build material is dispensed from the nozzle assembly 288 onto the build plate 220 to form an object, the extruder hopper 282 weight is reduced. Eventually the object is formed, or the material available in the extruder hopper 282 is exhausted. If the material is exhausted (or close to being exhausted), a weight sensor associated with the extruder hopper 282 detects a threshold weight has been reached, i.e., the weight of the extruder hopper 282 and contends is less than a threshold amount. The controller then releases additional build material, e.g., powder, from the main hopper 280 which falls into the extruder hopper 282 to refill the extruder hopper 282. Once the extruder hopper 282 is sufficiently refilled, as detected by the weight sensor, the main hopper is closed such that no more material is released into the extruder hopper 282. This process allows for seamless refilling of the extruder hopper 282 such that manufacturing, i.e., dispensing of the build material, is not interrupted. Further, blockages are less likely as all of the build material need not be stored in the extruder hopper 282.

Turning now to FIG. 17, a flowchart 300 illustrating a method of operating the powder dispensing mechanism 210 is illustrated. The method 300 comprises printing 302 a layer of the object on the build plate 220. Printing 302 may comprise dispensing powder from the powder dispensing mechanism 210. The method 300 further comprises changing 304 a z axis height of the build plate 220 to form the next layer of the object. The weight of the extruder hopper 282 is then taken at step 306. It is then determined if the extruder hopper 382 has enough powder to dispense an additional layer at step 308 based on the determined weight in step 306.

If the extruder hopper 282 has sufficient powder to print another layer, the method 300 proceeds to step 302 and another layer is dispensed, the build plate 220 is detected and the weight is again determined. If sufficient powder is no longer present in the extruder hopper 282, the method 300 determines which extruder hopper 282 requires additional powder at step 310 as additional extruder hoppers 282 may be present each at varying powder levels. The main hopper 280 is then moved to dispense additional powder into the extruder hopper 282 to refill the extruder hopper 282 in step 312. The extruder hopper 282 may be moved to be positioned under the main hopper 280 or the main hopper 280 may be moved to the extruder hopper 282. At step 314, the extruder hopper 282 is filled with additional powder. The volume of additional powder provided may be based on the detected weight, may be a pre-set amount, or may be controlled by an autonomously operating controller or operator.

The method 300 then proceeds to step 316 where it is determined if all extruder hoppers 282 have sufficient powder. If not, the extruder hopper 282, or main hopper 280 are again moved to the appropriate positioned in step 312 and additional powder is dispensed in step 314. If all extruder hoppers 382 are sufficiently refilled, then method 300 returns to step 302.

Once the object is formed then method 300 ends.

While the powder dispensing mechanism 210 has been described with reference to the furnace 200 of FIGS. 13 and 14, the mechanism 210 could be used with the described furnace 1. Additionally, the pump 270 could be used with the described furnace 1.

During dispensing of powder from the powder dispensing mechanism 210, the build plate 20 may be gradually lowered such that layers of an object may be formed on the build plate 220. Thus the layers formed in this manner may be generally vertical, i.e. formed in z axis.

In use the lids 214, 216 are opened such that the cavity 222 and build plate 220 are accessible to the powder dispensing mechanism 210. The powder dispensing mechanism 210 then moves along the x and y axes dispensing powder on the build plate 220. In particular, the powder dispensing mechanism 210 dispenses a support powder to form base layer of the object on the build plate 220. The powder dispensing mechanism 210 then dispenses powder to form one of more layers on the base layer on the build plate 220. The powder dispensing mechanism 210 may move in the x and y axes via the linear mechanisms to dispense powder and form the object in any three-dimensional shape or configuration. Further, as the powder dispensing mechanism 210 is dispensing powder, the build plate 220 may lower in the z axis. Once the object has been formed, the powder dispensing mechanism 210 is moved by the mechanisms such that the lids 214, 216 may close. The thermal elements 218 are then activated to heat treat/sinter the object. The upper lid 216 is then opened to release heat from the cavity 222. Once sufficient heat is released, the lower lid 214 is opened, and the heat treated/sintered object may be removed from the cavity 222.

It should be understood that the examples provided are merely exemplary of the present disclosure, and that various modifications may be made thereto.

1. A method of forming an object by additive manufacturing within a furnace comprising a body defining a cavity, and a lid affixed to the body, the lid comprising a lower lid and an upper lid affixed to the lower lid, the method comprising:
moving a build plate from a raised position to a lowered position within a cavity, the build plate for receiving build material to form an object thereon while moving from the raised position to the lowered position; and
sintering the object within the furnace, sintering comprising releasing heat from the cavity in the furnace by opening the upper lid.

2. The method of claim 1, wherein moving the build plate comprises lowering the build plate relative to an open end of the cavity.

3. The method of claim 1, wherein sintering the object comprises activating one or more of thermal elements positioned within the lid of the furnace.

4. The method of claim 1, wherein the upper lid is rotatably connected to the lower lid such that heat is released from the cavity away from a powder dispensing mechanism upon opening the upper lid, the powder dispensing mechanism for dispensing powder into the cavity to form the object.

5. The method of claim 1, further comprising forming an object on the build plate during moving the build plate from the raised position to the lowered position, wherein forming the object comprises dispensing powder from a powder dispensing mechanism into the cavity.

6. (canceled)

7. The method of claim 5, wherein dispensing powder comprises:
dispensing powder from a support powder dispenser to form a base layer on the build plate; and
dispensing powder from a build powder dispenser to form one or more layers on the base layer on the build plate, the base layer and one or more layers forming the object.

8. The method of claim 7, wherein one or more of dispensing powder from the support powder dispenser, and dispensing powder from the build powder dispenser comprises dispensing powder through an open end of the cavity.

9. The method of claim 7, wherein at least one of:
dispensing powder from the support powder dispenser comprises dispensing powder from a broad nozzle; and
dispensing powder from the build powder dispenser comprises dispensing a metal powder.

10. The method of claim 7, wherein dispensing powder from the build powder dispenser comprises dispensing powder from a fine nozzle.

11. The method of claim 5, wherein at least one of:
dispensing powder from the powder dispensing mechanism comprises positioning the powder dispensing mechanism in x and y axes; and
dispensing powder comprises:
dispensing powder from an extruder hopper, and
refilling the extruder hopper from a main hopper storing powder.

12.-14. (canceled)

15. A furnace for additive manufacture of an object, the furnace defining a cavity, the furnace comprising:
a build plate movable from a raised position to a lowered position within the cavity, the build plate for receiving build material to form an object thereon while moving from the raised position to the lowered position;
a heat source for sintering the object on the build plate within the furnace; and
a lid comprising an upper lid and a lower lid.

16. The furnace of claim 15, wherein the build plate is moveable in a z axis, and the furnace further comprises a movement mechanism for lowering or raising the build plate in the z axis.

17. (canceled)

18. The furnace of claim 15, wherein the heat source is positioned within the lid, or within the lower lid.

19. The furnace of claim 15, wherein the upper lid is hingeably connected to the lower lid to open in an opposite direction thereto.

20.-21. (canceled)

22. The furnace of claim 15, further comprising a powder dispensing mechanism for dispensing powder to form an object on the build plate.

23. The furnace of claim 22, wherein the powder dispensing mechanism comprises at least one of:
a support powder dispenser for dispensing powder to form a base layer on the build plate; and
a build powder dispenser for dispensing one or more layers on the base layer, the base layer and one or more layers forming the object within the furnace, or
wherein the powder dispensing mechanism comprises a plurality of powder dispensers, each powder dispenser for dispensing a different powder.

24. (canceled)

25. The furnace of claim 22, wherein the powder dispensing mechanism is mounted on a support frame, and wherein the support frame surrounds an open end of the cavity.

26. The furnace of claim 22, further comprising:
an extruder hopper for storing build material to be dispensed by the powder dispensing mechanism, and
a main hopper for storing build material to refill the extruder hopper.

27. (canceled)

28. The furnace of claim 15, wherein the heat source comprises one or more thermal elements, and wherein the one or more thermal elements are positioned within the lid.

29. (canceled)

30. A method of manufacturing an object via additive manufacturing, the method comprising:
obtaining an electronic file representing a geometry of an object; and
controlling the furnace of claim 15 to manufacture, over one or more additive manufacturing steps, the object according to the geometry specified in the electronic file.

31.-32. (canceled)
